(19) United States
(12) Patent Application Publication
(10) Pub. No.: US 2026/0080364 A1
(43) Pub. Date: Mar. 19, 2026

(54) CASE MANAGEMENT SYSTEMS AND METHOD

(71) Applicant: Grand River Solutions, Saratoga, CA (US)

(72) Inventors: Joseph STORCH, Delmar, NY (US); Kelly GALLAGHER, Philadelphia, PA (US); Morgan CLIFFORD, Troy, NY (US); Roma SHAH, Glen Cove, NY (US); Jody SHIPPER, Napa, CA (US); Cherie SCRICCA, Napa, CA (US); Cassio CONCEICAO, Los Altos, CA (US)

(21) Appl. No.: 18/888,056

(22) Filed: Sep. 17, 2024

(51) Int. Cl. G06Q 10/10; G06Q 10/107; G06Q 50/20

(52) U.S. Cl. CPC G06Q 10/103; G06Q 10/107; G06Q 50/20

(57) ABSTRACT

Disclosed herein is an exemplary caseload management system, including a processor and a non-transitory computer-readable medium including computer executable instructions for configuring the processor to carry out a method including: providing an electronic user interface that allows system users to remotely access case information via a web-based content access user interface; implementing a system service including: a file management system, a calendaring system, a communications system, and a rules, policies and procedures system; maintaining a database of content accessed by the users via the web-based content access user interface; and extracting portions of the content from the database and providing the content to the users through the web-based content access user interface, in which providing the content to the users involves providing the content to at least six different types of users, and in which each of the different types of users is allowed access to different levels of information.

### PRIORITY CLAIM

None.

### INCORPORATION BY REFERENCE

All publications and patent applications mentioned in this specification are herein incorporated by reference in their entirety to the same extent as if each individual publication or patent application was specifically and individually indicated to be incorporated by reference.

### BACKGROUND

Case management and compliance with federal and state laws as well as institutional policies is challenging for organizations. This particularly applies to higher education and K-12 institutions where investigations of potential violations can be disorganized and non-transparent for parties involved, such as Title IX and non-Title IX investigations of sexual misconduct by and affecting students. Title IX of the Education Amendments of 1972 protects individuals from sex-based discrimination and harassment in school and education programs that receive funding from the U.S. government. Sexual misconduct and harassment may include sexual violence, stalking, dating violence, sexual assault, stalking, etc.

Title IX investigations may be complicated and lengthy procedures, often taking up to six months or longer and involving hearing and appeals and other procedures requiring parties to take certain actions by set deadlines. Parties involved in such investigations may include, for example, complainants, respondents, investigators, coordinators, advisors, and stakeholders. Challenges include transparency and disorganization of information, with different parties having limited or incomplete access, or needing restrictions put on the information they can access about a case. Distraught students and their representatives involved in such cases may not be able to effectively reach or get information from administrative and organizational staff in charge of case management regarding their case status, deadlines, their rights and responsibilities, what actions they need to take, who the investigators and coordinators assigned to their case are, and how to best communicate with them. Conversely, academic staff including investigators and coordinators may have difficulty communicating with students and communicating among themselves to access, collaborate on, transfer and evaluate case documents and updates, and to know who the parties involved in a case are and their roles and responsibilities. Furthermore, privacy and safety concerns regarding case-related communications factor in, for example, for complainants who may be in hostile environments involving sexual violence or other dangers.

Beyond sexual misconduct-related investigations in academic settings, case management software may also be used for other applications such as monitoring and responding to potential violations of alcohol and drug policies in institutions and organizations or potential discrimination on the basis of other federal or state laws such as Title VI of the Civil Rights Act of 1964, Title VII of the Civil Rights Act of 1964, Section 504 of the Rehabilitation Act of 1973, or the Americans with Disabilities Act of 1990.

Still further, separate or even mutually exclusive laws and regulations may need to be selected and applied to a specific case such as a Title IX investigation and may involve choosing among federal and state laws and even considering institutional policies, as well as determining which laws or policies should not be applied. Case-specific information such as whether a potential violation occurred on or off a college campus may determine the law applied and possibly procedures followed, administrative staff involved, etc.

Accordingly, there is a need for a centralized and transparent case information tracking, management, and communications system customized to the needs and access levels of various parties involved in various cases and investigations that institutions such as higher education institutions may regularly deal with.

### BRIEF DESCRIPTION OF THE DRAWINGS

The novel features of the invention are set forth with particularity in the claims that follow. A better understanding of the features and advantages of the present invention will be obtained by reference to the following detailed description that sets forth illustrative embodiments, in which the principles of the invention are utilized, and the accompanying drawings of which:

FIGS. 1-5B show user interfaces for an end user of an exemplary embodiment of a caseload management system constructed according to aspects of the present disclosure.

FIG. 1 shows a user interface for a list of cases relating to an end user of the exemplary caseload management system.

FIG. 2 shows a user interface for a profile of an end user of the exemplary caseload management system.

FIGS. 3A-3C show case-specific user interfaces of the exemplary caseload management system.

FIG. 3A shows a user interface for a case-specific overview of a case in the exemplary caseload management system.

FIG. 3B shows a user interface for case progress of a case in the exemplary caseload management system.

FIG. 3C shows a user interface for case documents for a case in the exemplary caseload management system.

FIG. 4 shows a user interface listing details for advisors in the exemplary caseload management system.

FIGS. 5A-5B show an end user preferences user interface of the exemplary caseload management system.

FIGS. 6A-14C show user interfaces for administrators of the exemplary caseload management system.

FIG. 6A shows an overview and site interface of the exemplary caseload management system.

FIG. 6B shows a site-specific interface of the exemplary caseload management system.

FIG. 6C shows a site-specific procedures interface of the exemplary caseload management system.

FIG. 7 shows a case list interface for an administrator of the exemplary caseload management system.

FIG. 8 shows a roles interface for the exemplary caseload management system.

FIG. 9 shows a user interface listing details for administrative users of the exemplary caseload management system.

FIG. 10 shows an advisor listing user interface of the exemplary caseload management system.

FIG. 11 shows a report generator user interface of the exemplary caseload management system.

FIG. 12 shows a calendar user interface of the exemplary caseload management system.

FIG. 13 shows a user support request form interface of the exemplary caseload management system.

FIGS. 14A-14C show a client preferences user interface of the exemplary caseload management system including customizable case and institutional parameters.

FIG. 15 is a flow chart illustrating a method performed in an exemplary distributed response and resolution caseload management system having a web-based content access user interface.

### DETAILED DESCRIPTION

In general, described herein is an exemplary embodiment of a caseload management system configured to track, manage, and share files and correspondence across users of the system. For example, an integrative workflow enables communications among parties within the exemplary system, tracking automatically to a relevant case, provides status and deadline updates for cases. Users may be associated with a client organization that is a subscriber or customer of the exemplary caseload management system. Users may be parties to a case managed by the exemplary caseload management system and are enabled to upload evidence and information to the system and monitor progress in real time. The exemplary caseload management system may have different user interfaces and views customized to users and institutions. Users may include end users and administrators of the client organization. In certain examples, ends users may include complainants, respondents, and advisors (who may be attorneys hired by a complainant or respondent or friends and family of a complainant and respondent). Administrators may include investigators, coordinators, case managers, and supervisors. Institutional stakeholders may include department heads, deans, community members, and organizational counsel. In some embodiments, the exemplary caseload management system allows parties to track cases on the system via a secure and convenient app on mobile devices or via web-based interfaces. Furthermore, the exemplary caseload management system may offer parties control over when and how to receive case status updates, as well as what certain other parties such as their advisors receive. Thus, the exemplary caseload management system is configured to reduce e-mail traffic to the inbox of parties if they so desire.

Importantly, the exemplary caseload management system may offer a centralized platform for various parties such as administrators to consolidate, manage, share case files with stakeholders such as university counsel or academic deans, and even transfer cases. The platform also allows for compliance with federal and state laws as well as institutional policies which may often change, for example through automated features that identify and apply relevant laws and policies and ignore non-relevant ones.

In certain examples, the exemplary caseload management system automates steps and timelines for cases based on institutional policies and procedures. Supervisors and administrators can monitor case status, pull documents, collect data and reports, and communicate with team members.

Investigators may thus track each step of each case they are assigned, receive reminders of upcoming deadlines, and communicate with parties such as coordinators and stakeholders.

The exemplary caseload management system also allows coordinators to understand the status for each investigation and communicate with parties. Stakeholders may see status at a glance through customized dashboards and document permissions set by other parties such as investigators and coordinators.

Students who may be complainants and respondents can also have real-time access to their case updates via the transparency of case progress that the exemplary caseload management system offers. This is in contrast to traditional investigation scenarios where parties such as complainants and respondents who are often in a position of low authority feel frustrated and uninformed as they attempt to contact investigators and coordinators for updates. This can have negative results by undermining their trust in their institution.

The exemplary caseload management system may also allow parties to set communication preferences including do not disturb days and/or times, and in certain examples may allow parties such as complainants and respondents to determine what notifications and information other parties, such as their advisors, receive.

For example, according to one embodiment, there is an exemplary distributed response and resolution caseload management system, including a web-based content access user interface, including a processor and a non-transitory computer-readable medium including computer executable instructions for configuring the processor to carry out a method including: providing an electronic user interface that allows system users to remotely access case information via the web-based content access user interface; implementing a system service including: a file management system, a calendaring system, a communications system, and a rules, policies and procedures system; maintaining a database of content accessed by the users via the web-based content access user interface; and extracting portions of the content from the database and providing the content to the users through the web-based content access user interface, in which providing the content to the users involves providing the content to at least six different types of users, and in which each of the different types of users is allowed access to different levels of information.

According to certain examples, the at least six different types of users include case coordinators, case investigators, institutional stakeholders, a complainant and respondent in a particular case, advisors or attorneys to the complainant and respondent, and decisionmakers.

According to certain examples, at least the case coordinators, the case investigators and the institutional stakeholders are each allowed to access content related to multiple response and resolution cases.

According to certain examples, the case investigators are provided access to less content than the case coordinators are, and the institutional stakeholders are provided access to less content than the case investigators are.

According to certain examples, the communications system is configured to receive, store, sort, display, create and send email messages between the users and track the email messages relative to a case to which they relate.

According to certain examples, the communications system is configured to send updates to the users.

According to certain examples, the communications system is configured to allow a complainant and a respondent to restrict times during which they receive communications, further wherein the communications system is configured to allow the complainant and respondent to restrict at least one of the six different types of users from receiving communications from the communications system, in which the at least one of the six different types of users includes the advisors or attorneys to the complainant and respondent.

According to certain examples, the rules, policies and procedures system is configured to store and retrieve rules, policies and procedures related to at least one of a group including: Title IX of the Education Amendments of 1972, the Clery Act of 1990, the Americans with Disabilities Act of 1990, sex-based discrimination, diversity, equity, and inclusion.

According to certain examples, the rules, policies and procedures system is configured to automatically provide time-sensitive alerts to at least some of the users based on requirements found in the rules, policies and procedures.

According to certain examples, the rules, policies and procedures system is configured to automatically provide alerts to at least some of the users based on requirements found in the rules, policies and procedures, after resolving conflicts between inconsistent requirements.

According to certain examples, the rules, policies and procedures system is configured to resolve the conflicts between the inconsistent requirements based at least in part on case-specific information that has been previously stored in the database.

According to certain examples, the case-specific information includes at least one of the following selected from a group consisting of the state in which an incident occurred, a specific location in which the incident occurred, the date an incident occurred, and a position held by the complainant and/or the respondent.

According to certain examples, the file management system is configured to allow the users to upload evidence and information directly onto the system.

According to certain examples, providing the content to the users includes allowing supervisors to monitor progress of a case in real time.

According to certain examples, the system is configured to simultaneously share status updates with parties on both a portal and through a text message or email format.

According to certain examples, the system is configured to allow the users to select one or multiple do not disturb times, during which information and system updates may be added to the portal, but the system does not send the user a text message or email, as they direct.

According to certain examples, the system is configured to allow the case coordinators or the case investigators to access a color-coding system that informs them when deadlines are coming up soon or are overdue.

According to certain examples, the system is configured to allow the case coordinators and the case investigators to go backwards within a case timeline and reopen a previous version of an item after it has been changed.

According to certain examples, the system is configured to allow the institutional stakeholders to update policies in the system, and the system applies updated procedural steps to future cases based on the updated policies.

According to certain examples, the system is configured to allow the institutional stakeholders to make procedural changes based on changes to law or regulation, and wherein the system automatically changes process steps and requirements in future cases based on the procedural changes made by the institutional stakeholders.

According to certain examples, the system is configured to allow the users to make changes to a case via an application residing on a mobile device and have those changes be instantly reflected on a web browser interface, and vice versa.

According to certain examples, a digital watermark is applied to one or more of case documents and the user interfaces accessed within the distributed system, wherein the digital watermark identifies the one of the six different types of users accessing the watermarked document or user interface.

In another embodiment, there is a non-transitory computer-readable medium including computer executable instructions for carrying out a method, performed in a distributed response and resolution caseload management system comprising a web-based content access user interface, the method including: providing an electronic user interface that allows system users to remotely access case information via the web-based content access user interface; implementing a system service including: a file management system, a calendaring system, a communications system, and a rules, policies and procedures system; maintaining a database of content accessed by the users via the web-based content access user interface; and extracting portions of the content from the database and providing the content to the users through the web-based content access user interface, in which providing the content to the users involves providing the content to at least six different types of users, and in which each of the different types of users is allowed access to different levels of information.

According to certain examples of this embodiment, the at least six different types of users include case coordinators, case investigators, institutional stakeholders, a complainant and respondent in a particular case, advisors or attorneys to the complainant and respondent, and decisionmakers.

According to certain examples of this embodiment, at least the case coordinators, the case investigators and the institutional stakeholders are each allowed to access content related to multiple response and resolution cases.

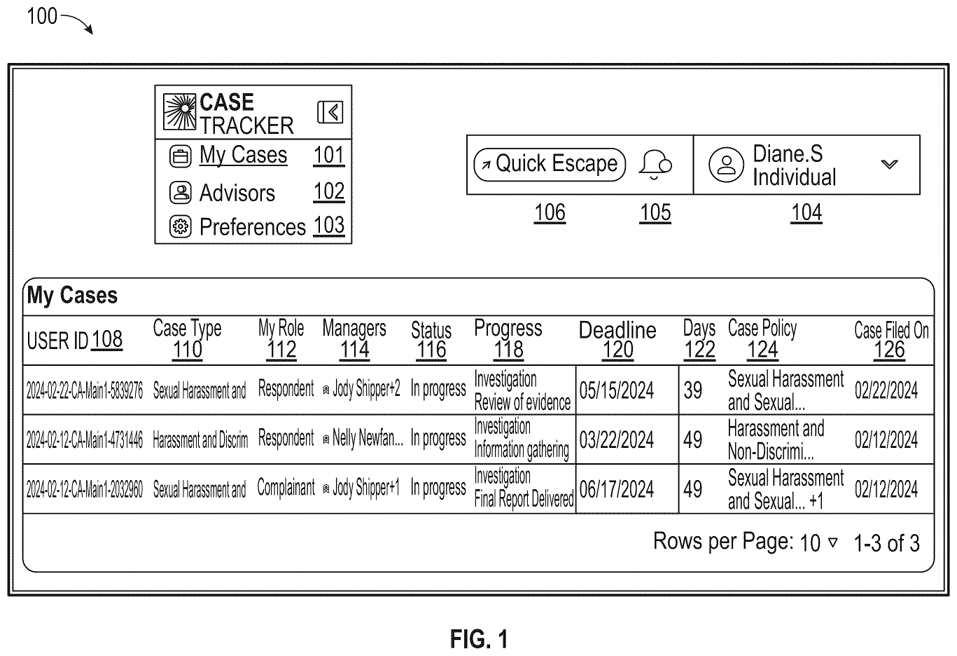

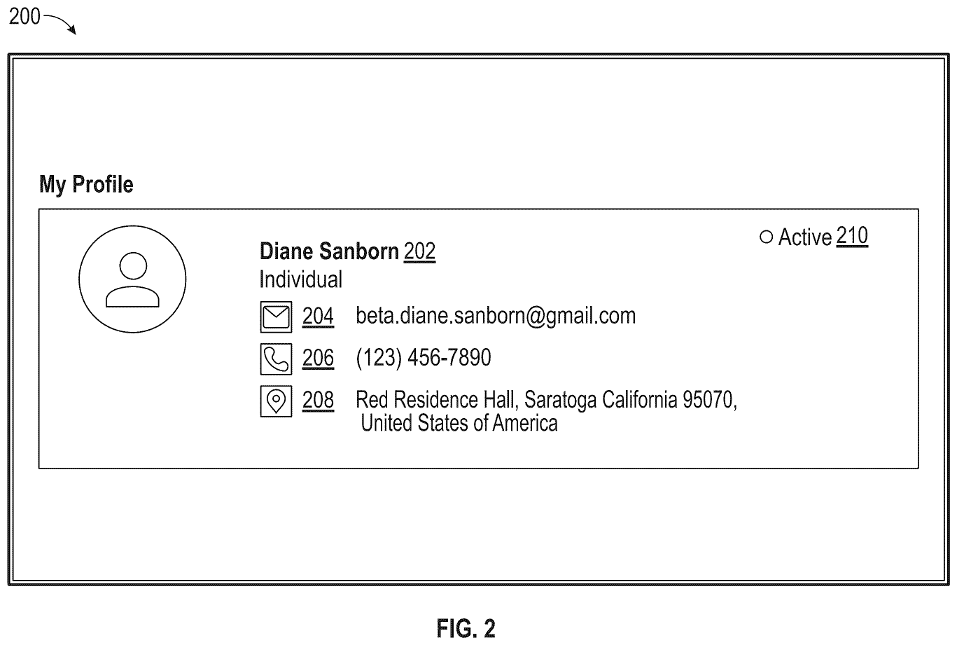

FIGS. 1-5 show user interfaces for an end user of an exemplary caseload management system, which may be configured to be customized to processes involving a plurality of policies, laws, and regulations. According to certain examples, the end users may be:
student complainant or respondents,
advisors or attorneys (which may be chosen by or appointed to complainants and respondents),
academic staff including hearing and appeals officers and panelists,
campus safety officers,
health and wellness and human resources staff,
institutional stakeholders such as academic leadership including deans, and
external stakeholders including external co-plaintiffs and co-respondents, or government and corporate representatives.

In certain examples, other terms may be used by institutions for a complainant and a respondent.

Each type of end user may have their own customized user interface with limited or restricted views of case status, case documents, individual contact or other information such as health information, etc. relevant to their role or job function's access and permissions level.

The exemplary caseload management system aims to provide transparency in case management and progress from complaint to resolution. In certain examples, case progress is updated in user interfaces of various parties and may indicate estimated completion times for steps in the case, and that a step in case progress is taking longer than normal.

In certain examples, end users may not be able to make changes to case data or user interface options and may only be able to access user interfaces and case data that only regard them. In yet other examples, end users may create and upload documents using templates.

To address privacy concerns, a digital watermark feature may be introduced into case documents and displayed user interfaces of the caseload management system. The digital watermark may be unique to a user of the system and identify the user who accessed the document or user interface. This will identify the responsible user in a situation where a document or screenshot of the caseload management system is shared with unauthorized persons or the public.

FIG. 1 shows a user interface 100 for a list of cases relating to an end user of an exemplary caseload management system. Clickable tabs or sections of user interface 100 may include a list of the end user's cases 101, advisors for the end client 102, and preferences 103. A drop-down menu 104 may include access to a user profile for the end user and the ability to modify a password for the end user's account. Case notifications may display as a ribbon or alert icon 105. A quick escape button 106 provides the ability for end user to quickly hide user interface 100 or other user interfaces of the caseload management system. This may be advantageous for privacy and safety concerns, such as when an end user is accessing the caseload management system via a mobile device or web interface and is in the presence or vicinity of aggressors or other people that they do not want to be aware of their case or personal information.

Also shown is a list of cases which may be sorted by user ID 108 (which may be an alpha-numeric string), case type 110 (which may include sexual harassment and discrimination), the end user's role 112 (such as respondent or complainant), managers 114, case status 116, case progress 118 (which may include review of evidence, information gathering, and final report delivered), as well as deadlines 120, number of days that the case has been ongoing 122, institutional policies, laws, or regulations that apply to the case 124, and the date that the case was filed 126.

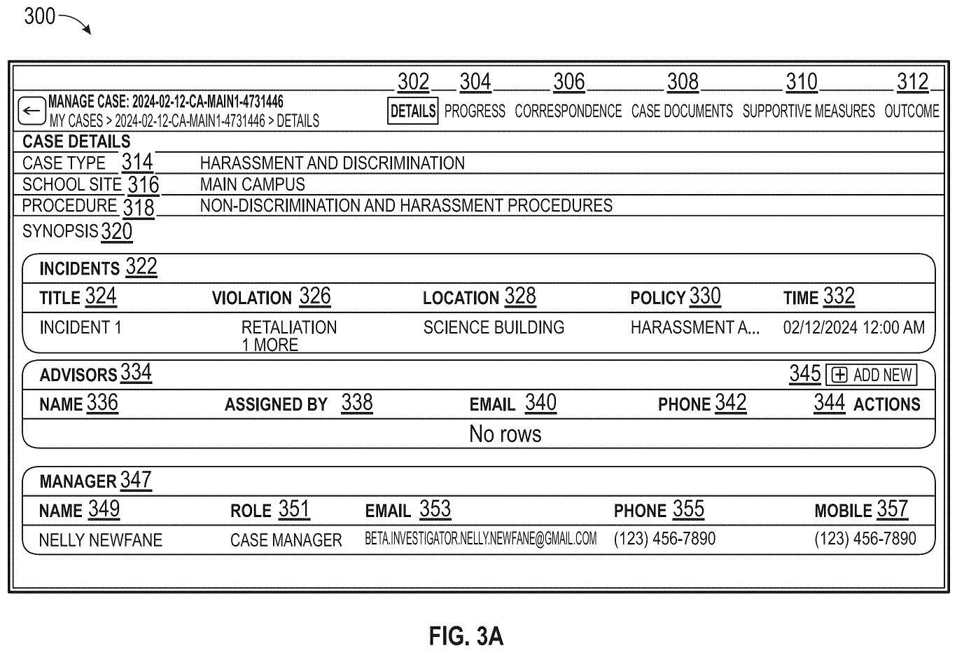

FIG. 2 shows a user interface 200 for a profile of an end user of the exemplary caseload management system. Demographic information for the end user may be displayed including name 202, e-mail address 204, phone number 206, and address 208, as well as active or inactive status 210 in the caseload management system. In some examples, this demographic information may be editable by the end user via an interactive or clickable icon.

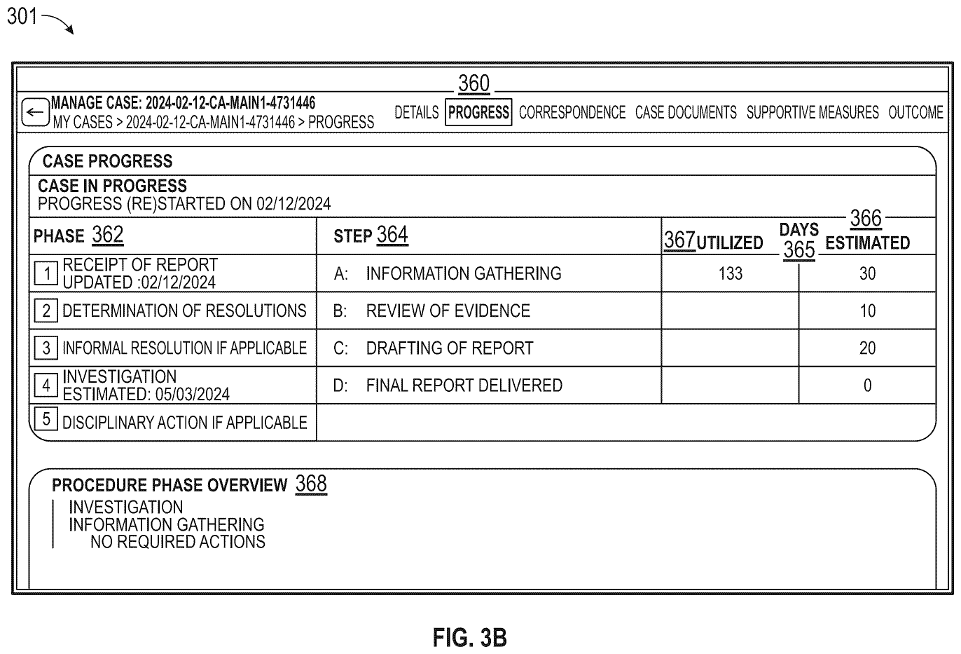

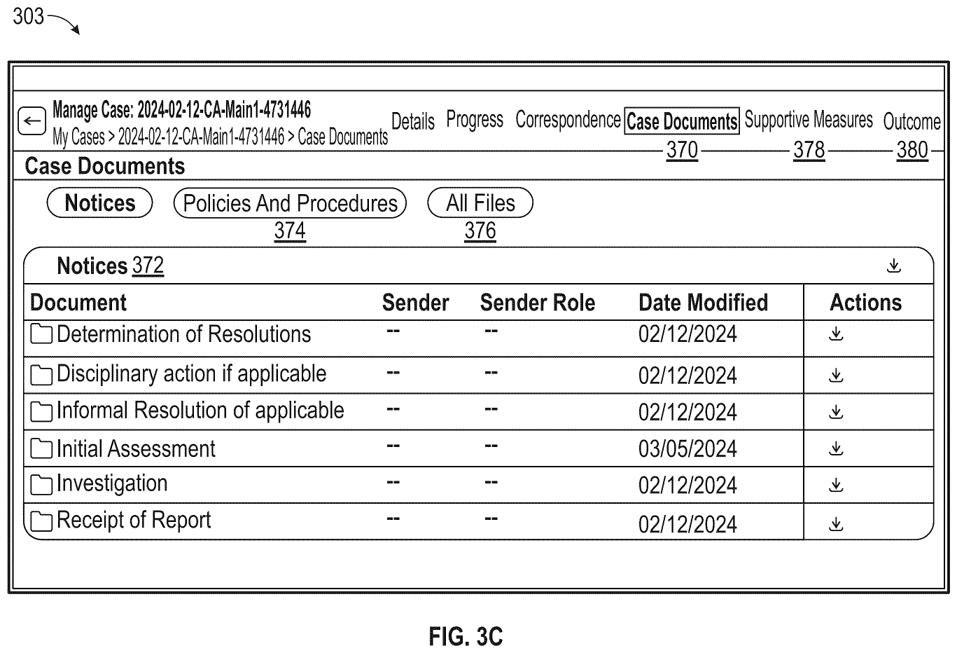

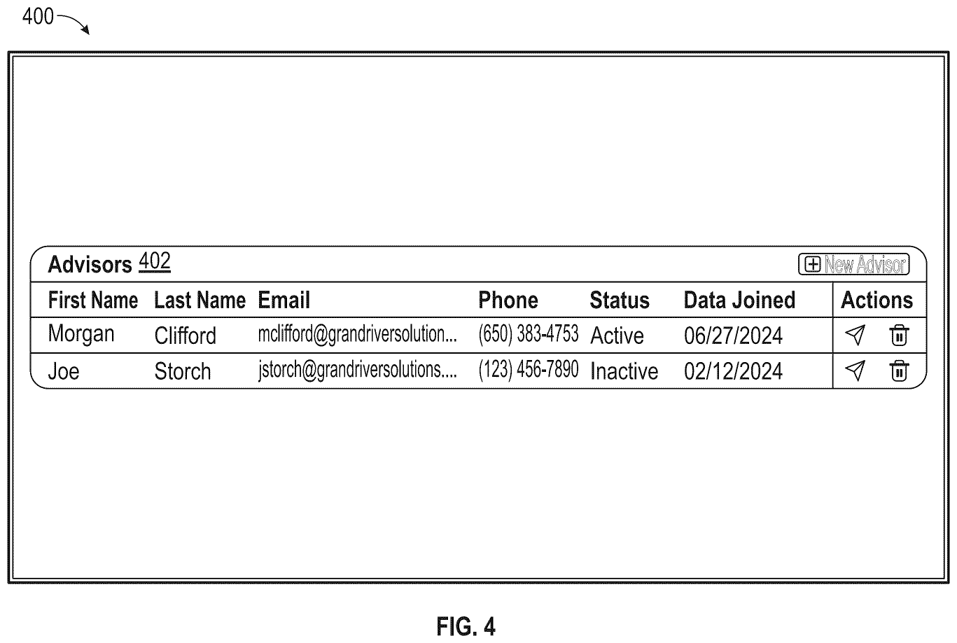

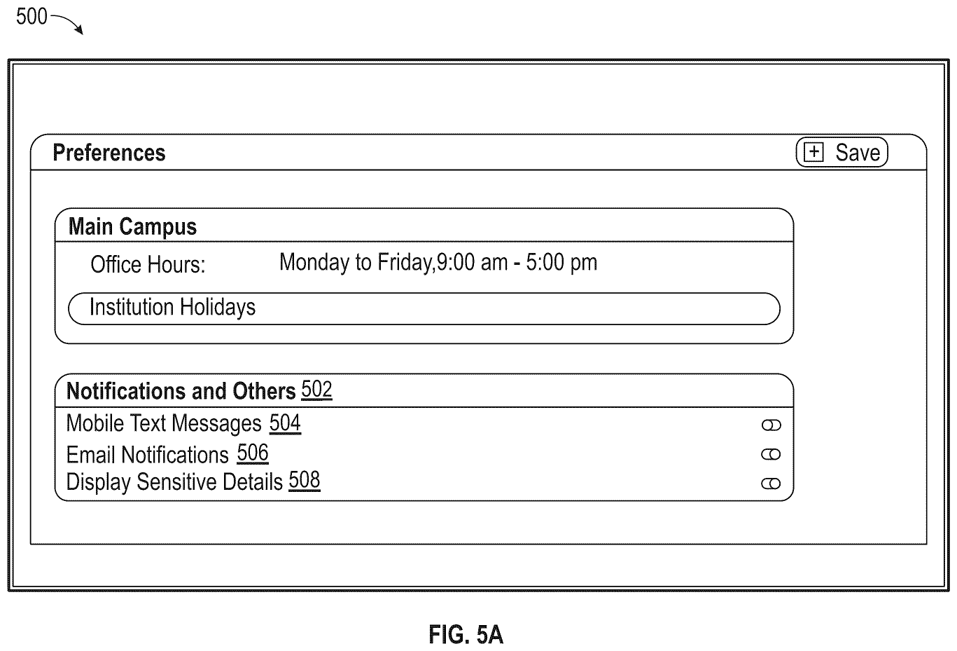

FIGS. 3A-3B show case-specific user interfaces 300-301 of the exemplary caseload management system.

FIG. 3A shows a user interface 300 for a case-specific overview of a case in the exemplary caseload management system. Various clickable tabs may include case details 302, case progress 304, case correspondence 306, case documents 308, supportive measures taken for the case 310, and case outcome(s) 312.

Case details may also be displayed such as case type 314, client site or sub-department relevant to the case 316, procedures applying to the case 318 and a case synopsis 320.

Incidents 322 triggering the case may also be listed, including a title for the incident 324, alleged violation type 326 (such as retaliation, assault, etc.), location of the alleged violation 328, policy applying to the violation 330, and approximate time that the alleged violation occurred 332.

Advisors 334 assigned to or chosen by a complainant and/or respondent may also be listed, including their name 336, who assigned or selected them 338, their email address 340, phone number 342, and relevant actions 344 taken by them or by administrators regarding them. New advisors may also be added 345.

Information about managers for the case 347 may also be displayed including name 349, role 351 (such as case manager), e-mail address 353, phone number 355, and mobile number 357.

FIG. 3B shows an exemplary user interface 301 for case progress of a case in the exemplary caseload management system. Case progress 360 details may include a phase history including current phase and step of the case. Phases 362 of a case may include receipt of report, determination of resolutions, informal resolutions if applicable, investigation (and actual or estimated date), and disciplinary actions if applicable. Other phase examples may include formal complaint, notice of allegations, informal resolution (if applicable), investigation, hearing, and opportunities to appeal.

Each phase may have various steps 364. Receipt of report phase may include various steps 364 such as initial outreach, follow-up outreach, and final outreach to parties such as, for example, complainants and respondents. Determination of resolutions phase may include steps 364 such as an initial meeting and a confirmation of resolution selection. Informal resolution phase steps 364 may include meeting with parties, consideration of terms for a resolution, and finalizing terms for a resolution. Steps 364 for a disciplinary action of a phase may include having a report reviewed by a manager, and an action being determined and finalized. Steps 364 for an investigation phase may include informal gathering, review of evidence, drafting of report, and final report delivered.

Also displayed may be indicated estimates of time 366 (i.e. days) for completing each step, and actual time utilized to complete each step.

A procedural phase overview 368 summarizing the current status of a case's phase and step may also be shown.

FIG. 3C shows an exemplary user interface 303 for case documents 370 for a case in the exemplary caseload management system. In certain examples, case documents 370 may include text and/or explanations of relevant federal and state law as well as organizational policies and procedures. As shown here, there is a tab or clickable icon for notices 372, which may list documents and folders, including information about the sender, the sender's role, date modified, and actions that can be taken such as downloading the document. Case documents 370 may be related to determination of resolutions, disciplinary action, informal resolution, initial assessment (including complainant, respondent, and witness provided documents), investigation reports (including related and relevant evidence), alternative solutions, and receipt of report.

In certain examples, there may be another exemplary user interface, tab, or clickable icon for policies and procedures 374 showing documents and folders, for example institutional policies on harassment and non-discrimination, again with information about the sender, sender's role, date modified, and actions such as downloading the documents.

There may also be a tab or clickable icon to see all files and documents 376, and a feature to upload or remove documents.

Supportive measures taken for the case may also be displayed via clickable icon 378 and may include interim measures, supportive measures, and accommodations, with information on titles, effective date, completed date, and description.

Case outcomes 380 may also be displayed via a clickable icon 380 and may include information on case remedies, sanctions, and confirmed violations of incidents including findings and appeal descriptions.

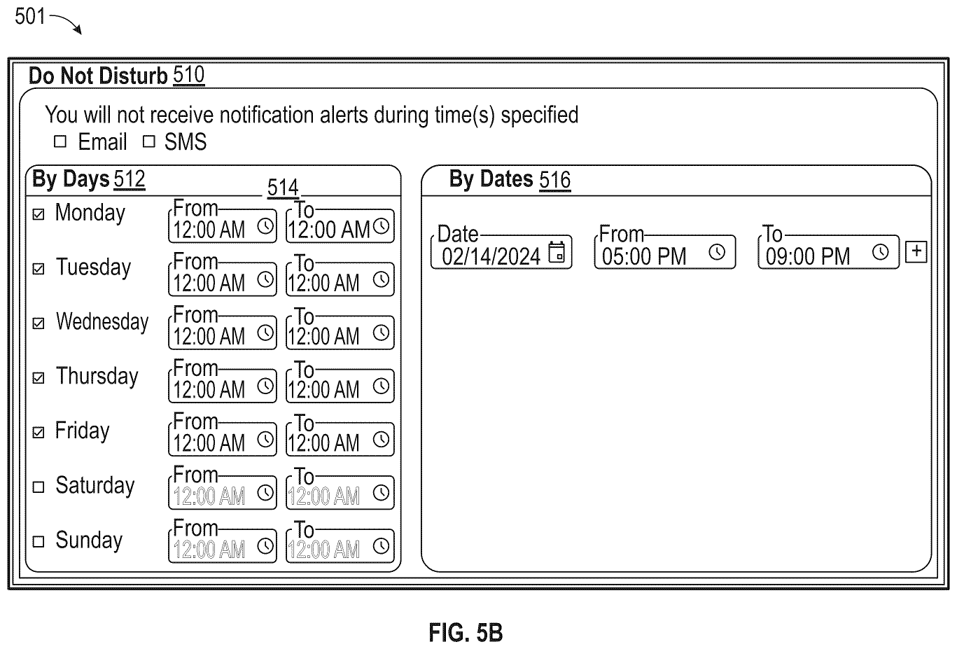

FIG. 4 shows an exemplary user interface 400 listing contact and other details for advisors 402 in the exemplary caseload management system. In certain examples, end users such as complainants and respondents may add/invite or remove/inactivate advisors. Advisors may be legal counsel, family and friends, academic staff, or community members that the complainant or respondent has selected to advise them in the case. Advisors may access case data, updates, and notifications via their own separate user interface(s). In certain examples, the complainant, respondent, or administrators may control the information that advisors may access from the caseload management system and the notifications that advisors receive from the caseload management system.

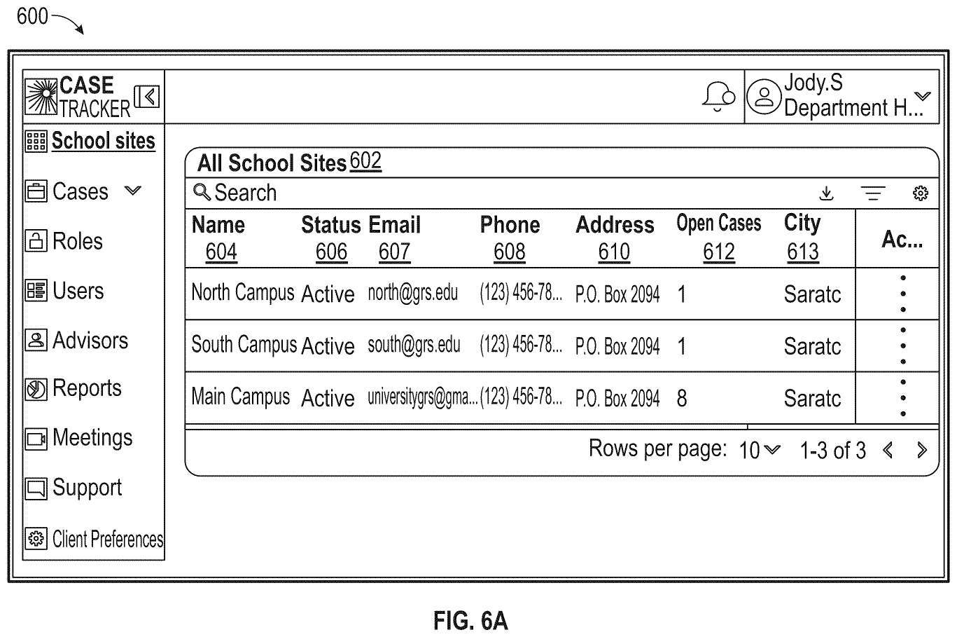

FIGS. 5A-5B show an exemplary end user preferences user interface 500-501 of the exemplary caseload management system.

As shown in FIG. 5A, end user preferences user interface 500 may list business hours for the institution and institutional holidays as a reminder to end users. Notifications 502 may be set or modified using interface 500, including turning on or off notifications in the form of mobile text messages 504, email notifications 506, and displaying or omitting sensitive details 508 within notifications such as description of incidents, identity information, case status, etc.

FIG. 5B shown another portion 501 of the exemplary end user preferences user interface for Do Not Disturb end user preference settings 510. As shown here, end users may choose not to receive e-mails or texts/SMS messages from the caseload management system.

Notifications can be silenced by day 512 and/or time 514, as well as one or more date ranges 516, each including a time range.

Do not disturb client preference setting may be especially advantageous in addressing privacy and safety concerns regarding case-related communications for complainants who may be in hostile environments involving sexual violence or other dangers, for example complainants who may be living with or in classes with an abuser or aggressor who may be the respondent and/or wish to prevent others from seeing notifications regarding their case or hearing alerts coming from their mobile device or computer.

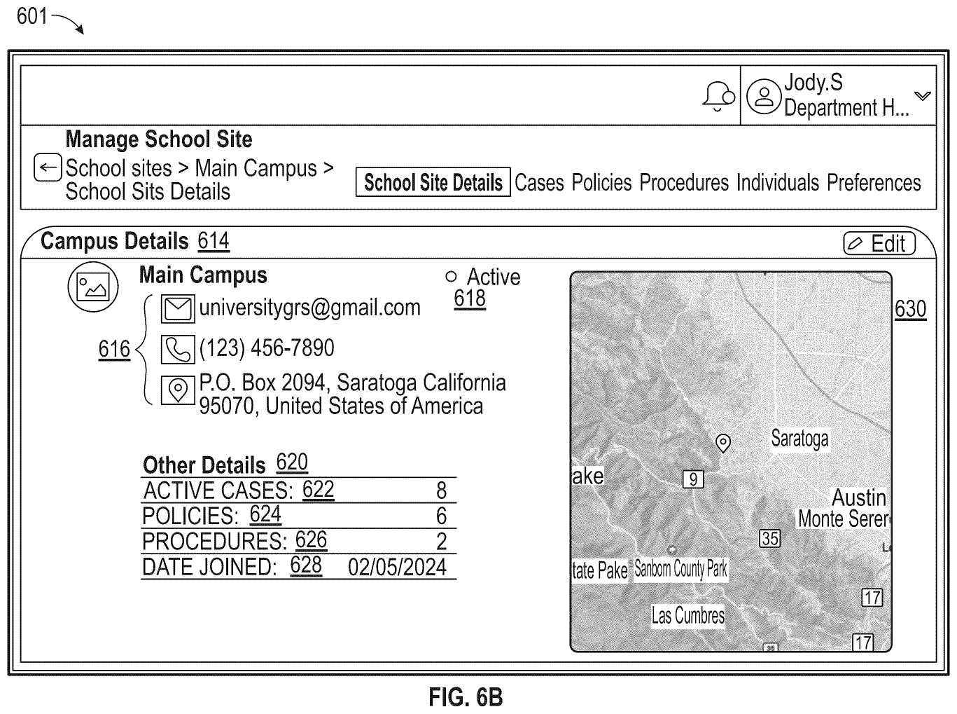

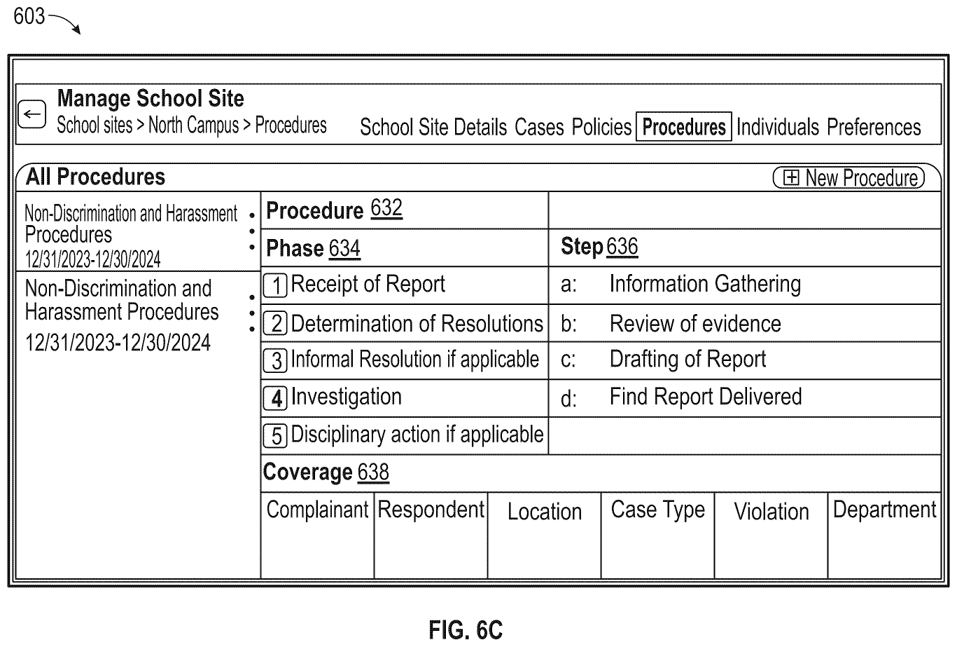

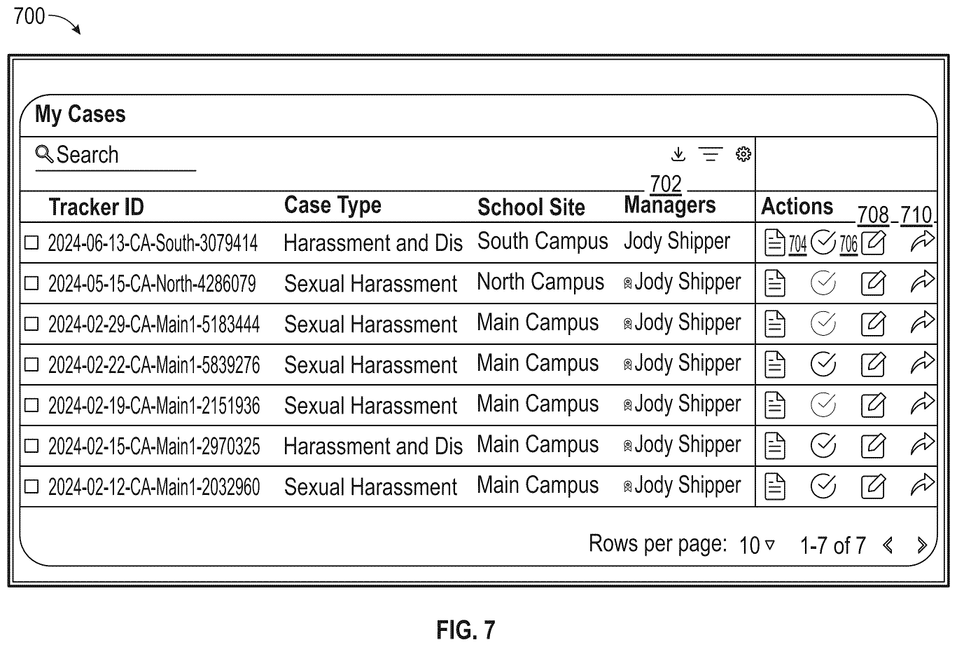

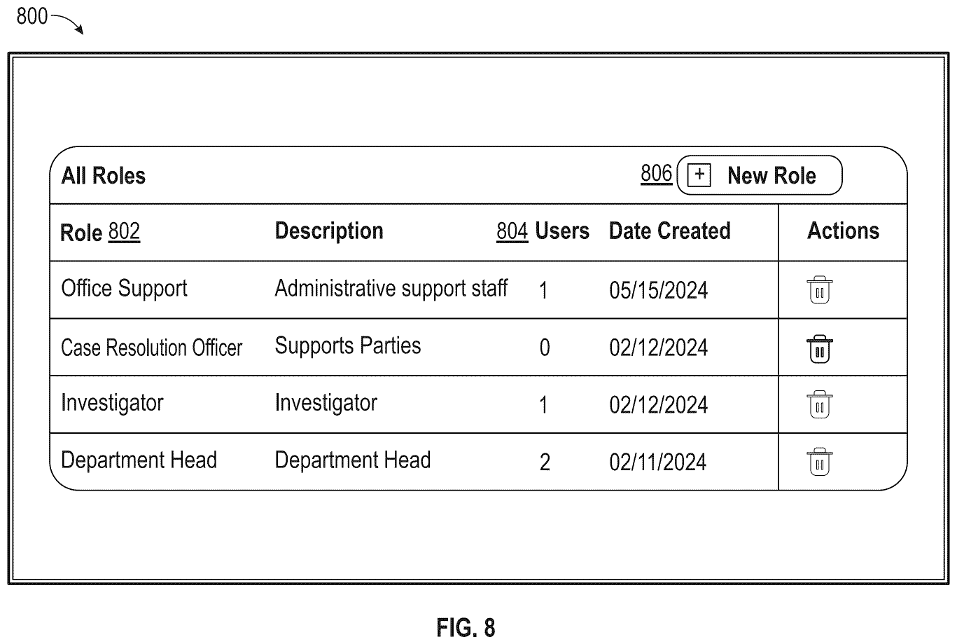

FIGS. 6A-14 show exemplary user interfaces for administrators of a caseload management system. According to certain examples, administrators may be case investigators, case coordinators, or case managers, as well as off-hours staff or third-party administrators. In certain examples, the case investigators may have access to the most complete view of user interfaces and case data in the caseload management system, and the case coordinators and managers may have a more limited access.

In certain examples, administrators may be able to pause case status and progression, and to create or upload files based on templates, and restrict the abilities of other parties to access and download files. In certain examples, there may be a user profile interface providing a profile and contact information for an administrator of the caseload management system.

FIG. 6A shows an exemplary overview and site interface 600 of the exemplary caseload management system. As shown here, there are various sites 602 for a client organization, with a list of sites by name 604 which may be campuses or departments of an organization. An active/inactive status 606 of the sites may be displayed, as well as contact information for the site including phone number 608, e-mail address 607, address 610, number of open cases 612, city 613, etc.

FIG. 6B shows a site-specific interface 601 of the exemplary caseload management system. Interface 601 provides editable information on site/campus details 614, which may include contact information for the site 616, active/inactive status of the site 618 in the caseload management system, other details 620 which may include statistics on the number of active cases 622, policies 624, procedures 626, date joined 628, and a map 630 showing the site.

FIG. 6C shows an exemplary site-specific procedures interface 603 of the exemplary caseload management system. Interface 603 provides information on site procedures 632 with information fields for each procedure that applies to a site, such as non-discrimination and harassment procedures. Phase 634 and step 636 information for a case is also displayed, as described in FIG. 3B. In certain examples, procedures may be added, edited, or removed.

As shown here, each listed procedure 632 may have a coverage section 638 providing:
categories of complainants and respondents covered under a site's procedure (such as undergraduate or graduate students, and students of a school within a client organization such as a business school, college of education, law school, etc.);
locations within a site such as department building names, residence halls, off-campus locations, and online or digital (such as online harassment or sexual text messages);
case type such as harassment and discrimination and sexual harassment/sexual violence;
categories of violations including Title IX sexual harassment, non-title IX sexual harassment, sexual assault resulting in sexual intercourse, sexual assault resulting in sexual contact, dating violence, domestic violence, stalking, sexual coercion, sexual exploitation, retaliation, and discriminatory harassment;
department coverage for a procedure listing the schools within the client organization that a procedure applies to such as a college of arts and sciences, business school, law school, etc.

In certain examples, individuals such as a complainant, respondent, or witness may be listed along with their demographic and contact information in a sub-menu or tab of the site-specific interface 603. There may also be sub-menus or tabs listing operating information for a school site such as business days, academic calendar type, office hours, organizational closures, and the ability to color-code deadlines when displayed on a calendar or as text.

In certain examples, a policies user interface similar to procedures interface 602 may be accessible in the caseload management system to provide coverage information for parties, locations, case type, violations, and departments that a policy applies to. Documents describing or relating to various policies may also be accessible via such an interface, including: a Title IX and Civil Rights Standard Campus Policy, a sexual harassment and sexual violence policy, a harassment and non-discriminatory policy, and a test or placeholder policy.

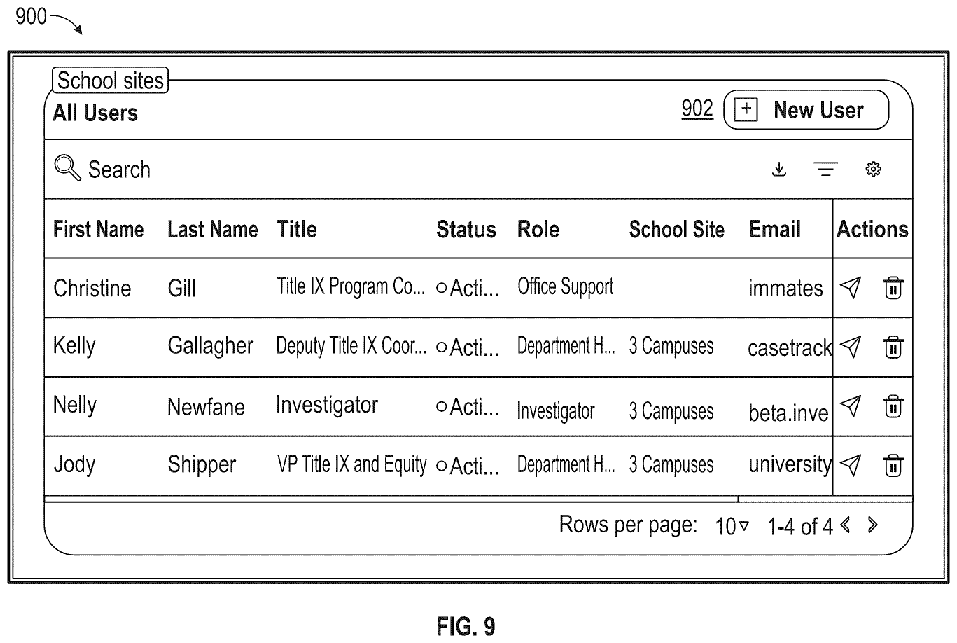

FIG. 7 shows an exemplary case list interface 700 for an administrator of the exemplary caseload management system. As shown here, cases managed by an administrator may be displayed and/or sorted by tracker ID, case type, school site, and case manager 702. An administrator may add case notes 704, update case progress 706, compose case correspondence 708, and even transfer 710 or assign the case to another administrator. In certain examples, there may be another user interface displaying all cases for an organization or site, with similar features. In yet other examples, there may be a case request feature for an administrator to create and/or approve or reject a case request, including displayed information about the date a case was received, case type, complainant and respondent information, incident date, incident location, and attachments and notes.

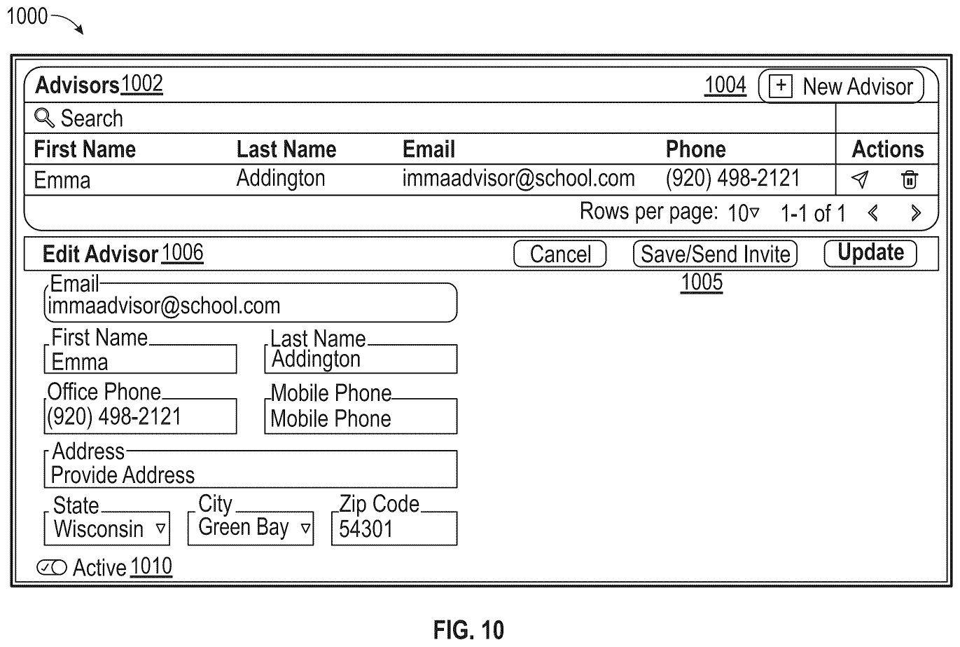

FIG. 8 shows an exemplary roles interface 800 for the exemplary caseload management system. As shown here, the roles 802 of various administrators using or having an account within the exemplary caseload management system may be listed and filtered by category, including, for example: investigators, department heads, office support, etc. along with a description of their roles and number of administrator users 804 for each role 802. In certain examples, roles may be added or removed.

In yet other examples, a master administrator may set permissions for the roles of various administrators, including the information they can view, update or delete regarding case details, progress, correspondence, documents, supportive measures, outcomes, notes, activity, school site policies, policies, preferences, individuals, reports, and advisors, as well as the ability of administrators to view system notifications.

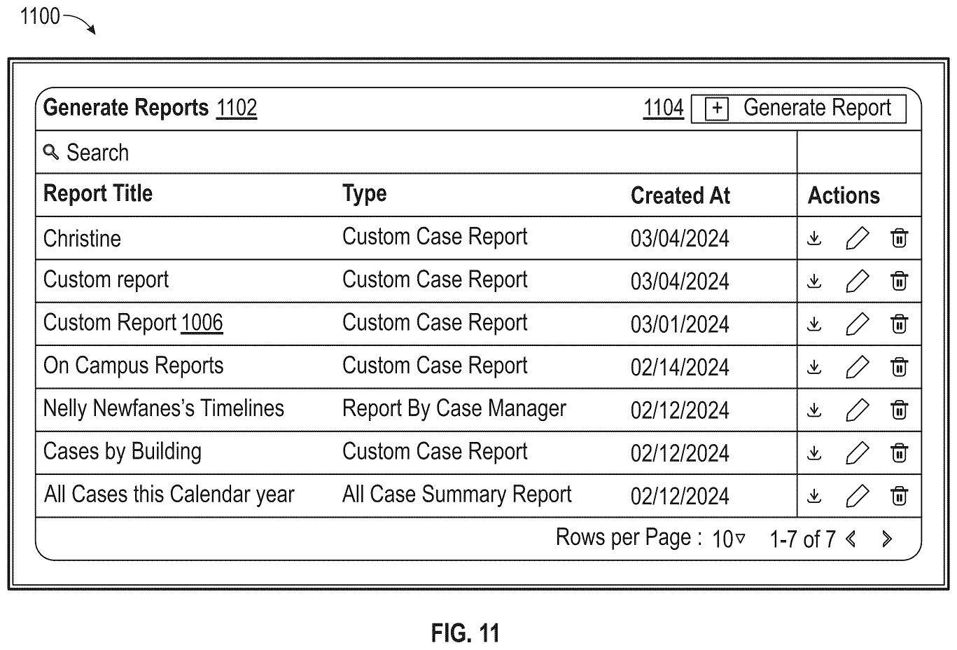

FIG. 9 shows an exemplary user interface 900 listing details for administrative users of the exemplary caseload management system. In certain examples, both administrative users and non-administrative users such as department heads (stakeholders) may also be listed. Contact information, titles, active status, site, etc. may be listed for administrative and non-administrative users of the caseload management system. Sub-menus or other user interfaces may display more details for a specific administrative or non-administrative user including (if applicable) their manager, staff type, and the total number of cases they are assigned to, as well as case status and site(s) of the specific user's cases. New administrative or non-administrative users may also be added 902.

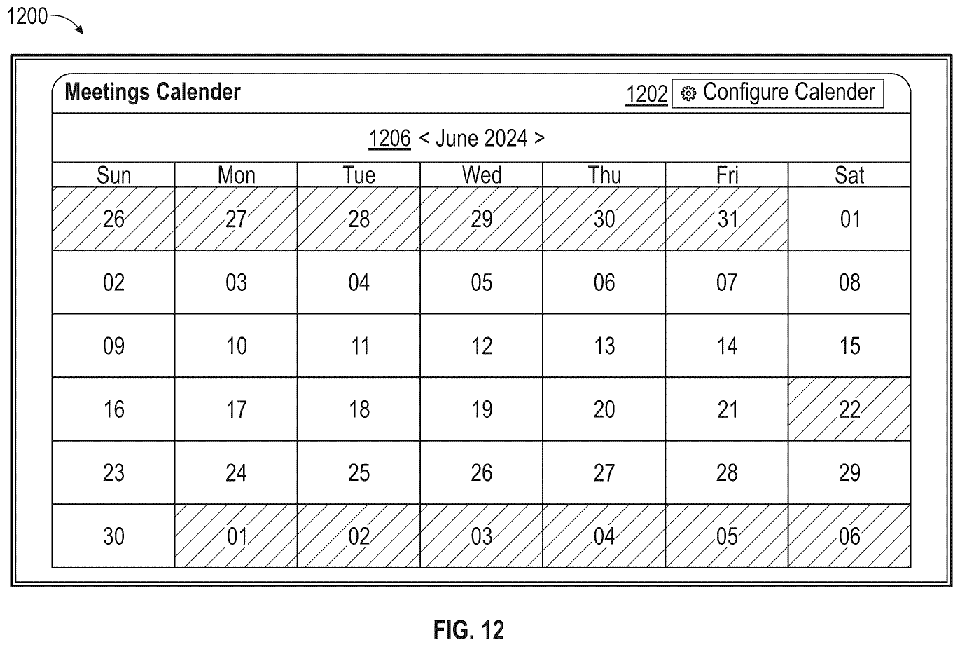

FIG. 10 shows an exemplary advisor listing user interface 1000 of the exemplary caseload management system. In certain examples, administrators may view and edit 1006 advisor contact and other information and add 1004/invite 1005 advisors, remove advisors 1002, or activate/inactivate advisors 1010 via clickable icons and fields. Advisor may access case data, updates, and notifications via their own separate accounts and/or user interface(s) of the exemplary caseload management system.

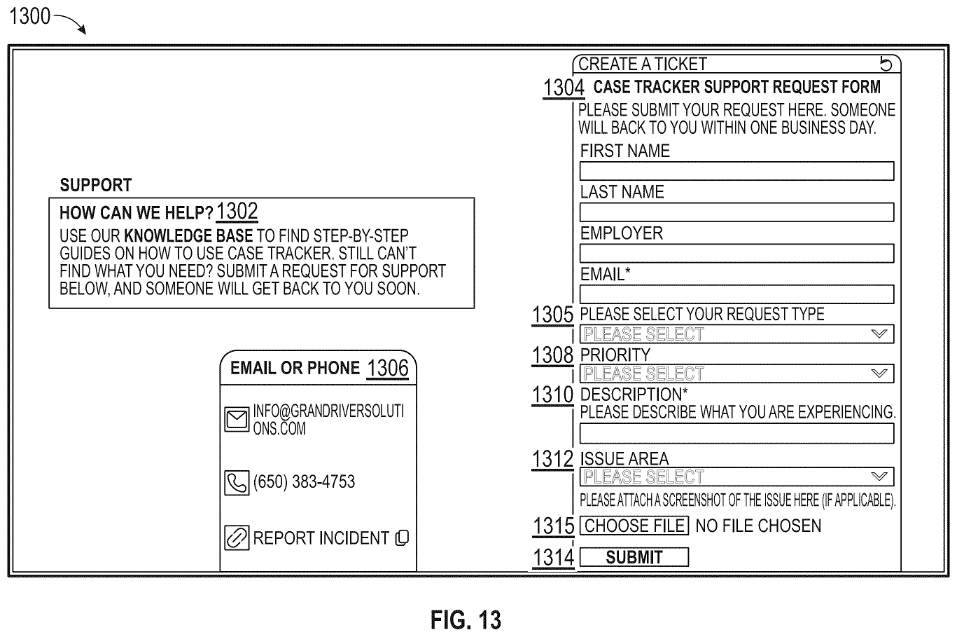

FIG. 11 shows an exemplary report generator user interface 1100 of the exemplary caseload management system including editable fields.

Case reports may be run to generate reports 1102 about cases and case progress, performance of investigators, etc. via a clickable icon 1104. Reports may also be run on, for example, a party to the exemplary caseload management system such as a complainant, or for an investigator's docket. Case reports may also be run for on-campus and off-campus incidents, cases by building or site, and for all cases in a certain time period.

In certain examples, various filters may be applied to case reports that are run, including filters for:
case status: such as initial assessment, in progress, stop, complete, and snooze;
case type: such as harassment and discrimination or sexual harassment and sexual violence;
incident location such as: a campus building, residence hall, or digital location such as e-mail or text that originated from a campus or off-campus network or server;
complainant or respondent type such as: an individual, department, unknown, or not applicable;
school site or organizational department/campus;
remedy such as: a social remedy, academic remedy, or financial remedy;
a sanction such as: disciplinary suspension, disciplinary expulsion, warning, disciplinary probation, or educational sanction;
case manager name;
applicable Clery Act provision or section, including arrests or disciplinary referrals for weapons, drug, or liquor law violations, as well as disclosures of various crimes such as criminal homicide including murder and non-negligent manslaughter, manslaughter by negligence, sexual assault, robbery, aggravated assault, burglary, motor vehicle theft, arson, hate crimes, domestic violence, dating violence, and stalking;
date ranges for when an incident occurred; and
date ranges for when a case was started or completed.

In certain examples, the system may run reports to check clearance, including determining which laws or policies apply to cases, and to remove mutually conflicting policies. For example, federal law may apply to investigations of potential violations occurring on a campus, whereas state law may apply to investigations of potential violations occurring off campus.

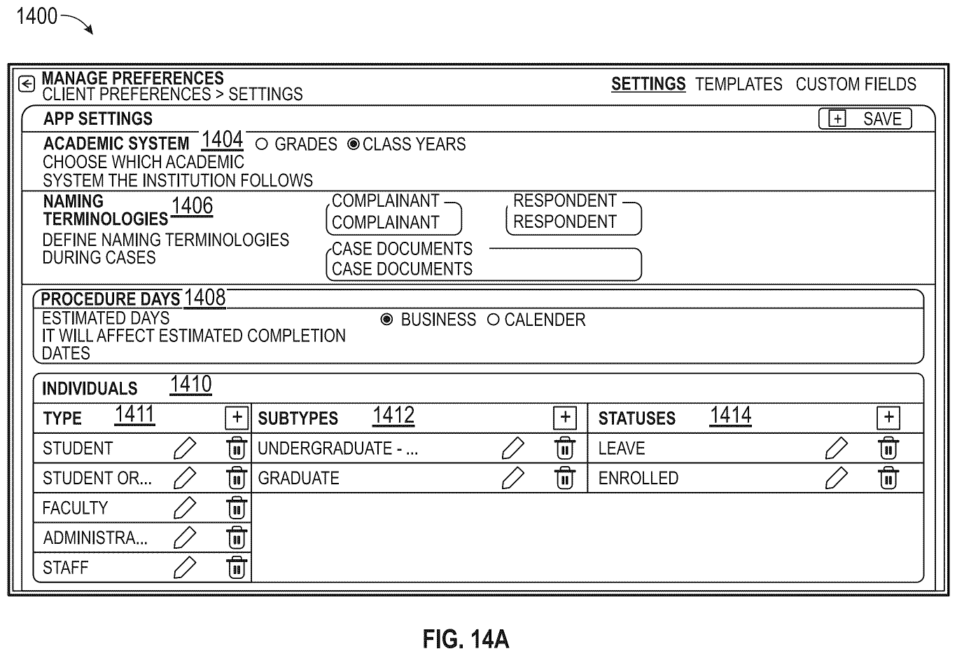

FIG. 12 shows an exemplary calendar user interface 1200 of the exemplary caseload management system. In certain examples, the calendar may display case related actions and meetings for the parties and may be synced with deadlines and other time-sensitive actions in the exemplary caseload management system as they apply to one or more administrators and/or end users. In certain examples, tracking deadlines and other measures of time may be based on business or calendar dates. Calendar views of the calendar user interface 1200 may include ranges or specific days, weeks, months 1206, and years. In certain examples, the calendar may be configured 1202 or synched to other calendars within or outside of the exemplary caseload management system such as a calendar of an administrator or university e-mail service.

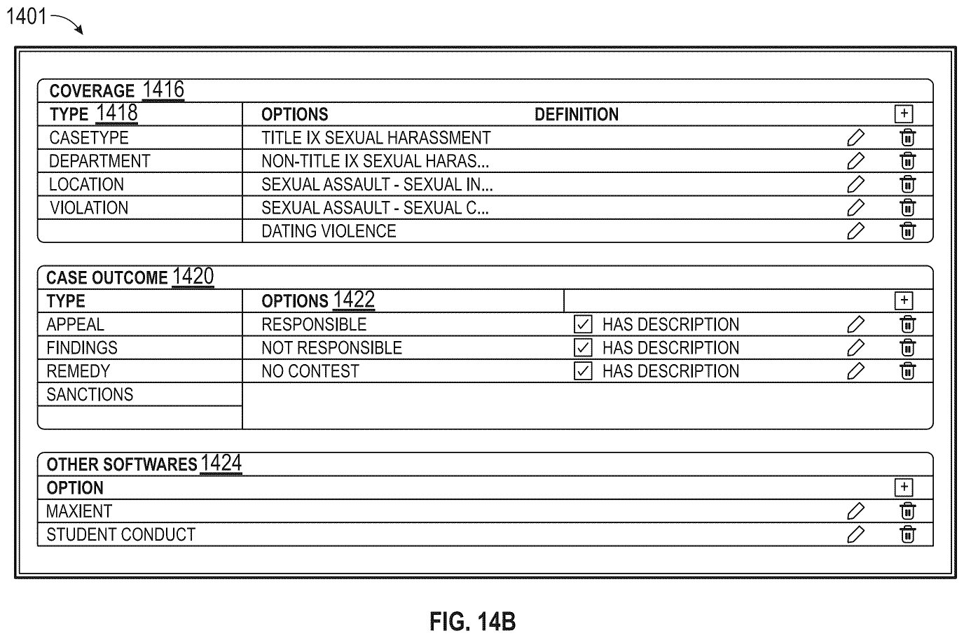

FIG. 13 shows an exemplary user support request form interface 1300 of the exemplary caseload management system. As shown here, administrators may access a link to a knowledge base 1302 which may include instructions and FAQs, for example in the form of articles, for using features of the exemplary caseload management system.

Such a knowledge base 1302 may be an external website providing tutorials for using the exemplary caseload management system including updating a profile or password, creating a new case, setting up user roles and permissions, managing and inviting users, viewing and managing cases, and scheduling meetings. Other articles and tutorials may include setting campus hours and calendar, updating campus contact information, creating and editing cases, viewing and managing cases including case requests and case notes, tracking and updating case status and progress including options to snooze or pause a case, and to change a deadline or step in the case. Articles may also be provided regarding how policies related to the case may be viewed and managed, including setting up policies and timelines for a case and color-coding case deadlines. Instructions may also be provided for drafting and managing case correspondence and allowing parties to disable e-mail notifications. Articles on other topics may include setting up roles and permissions for administrators. Finally, reporting and exporting data is also discussed, including generating case reports from report generator user interface 1100 of the exemplary caseload management system (see FIG. 11).

Contact information for the exemplary caseload management system administration 1306 may also be provided, including a link to report glitches or other issues with the system.

Administrators may have the option to submit 1314 an exemplary caseload management system support request form 1304 for a request type 1305 such as technical support, feature requests, billing and account management, or other issues. A priority level 1308 such as low, medium, or high may also be specified for the support request. A description of the issue 1310 may be inputted into the support request form, as well as attachments uploaded 1315. An issue area 1312 for the support request may also be selected, such as: case, policy, procedure, reporting, user management, or other.

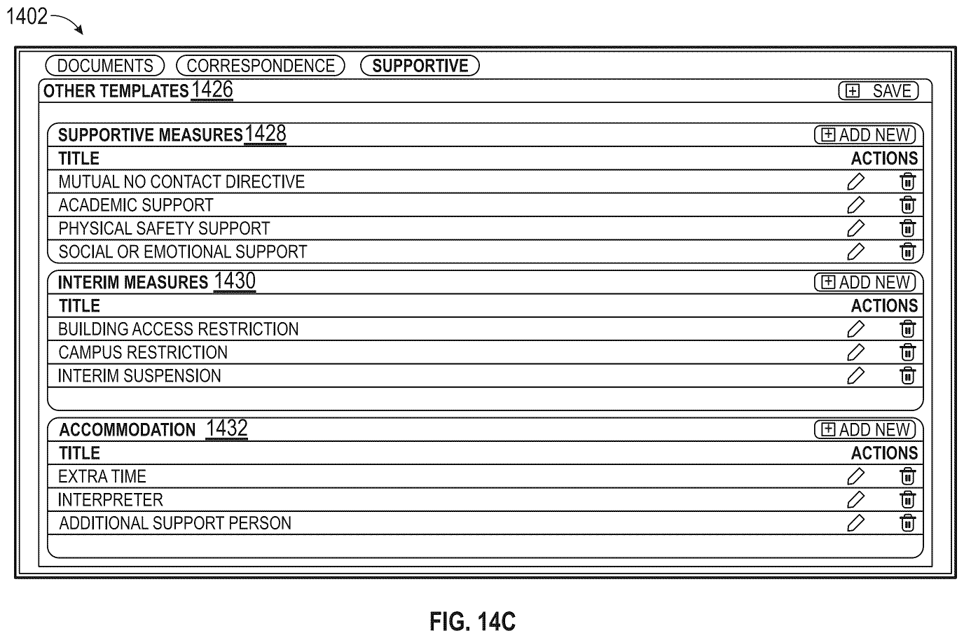

FIGS. 14A-14C show an exemplary client preferences user interface 1400 of the exemplary caseload management system including customizable case and institutional parameters.

Using exemplary interface 1400 as shown in FIG. 14A, administrators may set an academic system 1404 that the client organization follows such as class grade or class years.

Naming terminology 1406 that a client organization uses for complainants, respondents, and case documents may also be specified. Measurement methods for estimated days in a case procedure or step (procedure days 1408) may also be specified, for example, as a number of business days or a number of calendar days.

Titles of individuals 1410 such as end users or administrators involved in cases may also be added and removed. Types of individuals 1411 include student, student organization, faculty, administrator, staff, guest, visitor, volunteer, invitee, alumnus/alumna, or other non-affiliate. Sub-types 1412 and statuses 1414 for individuals may also be added or removed, such as graduate or undergraduate for student individual sub-type 1412, and on leave or enrolled for student individual status 1414.

FIG. 14B shows an exemplary coverage and case outcome settings display 1401 of interface 1400. Coverage 1416 may include adding or removing a specified type 1418 of case coverage for a case type, department, location (such as specified buildings), or violation type as previously discussed in FIG. 6C.

Case outcome 1420 may include adding or removing a type of case outcome such as an appeal, findings, remedy, and sanctions. Options 1422 for each case type may also be added or removed, and may include, for example:
modified, upheld, or sustained for an appeal case type,
responsible, not responsible, or no contest for a findings case type,
social remedy, academic remedy, or financial remedy for a remedy case type, and
warning, disciplinary probation, educational sanction, disciplinary suspension, or disciplinary expulsion for a sanction case type.

Descriptions and compatibility features for other software 1424 that a client organization uses or that may be used in conjunction with the caseload management system may also be added. Such other software may include, for example, Maxient software (provided by Maxient, LLC of Charlottesville, Virginia) or other case management software used to submit and manage student records for student conduct, academic integrity, student support, and Title IX matters. In certain embodiments, internal software for a client organization may also be included under other software 1424.

In certain examples, as shown in FIG. 14C, exemplary client preferences user interface 1402 may include features for creating templates 1426 for documents such as letters and notices. Such letters and notices may include investigation reporting letters, case correspondence, supportive measures 1428 documents (such as mutual no contact directives, academic support letters, physical safety support letters, social or emotional support letters), and interim measures 1430 documents such as building access restriction letters, campus restriction letters, and interim suspension letters. In certain examples, templates for accommodation support documents 1432 for parties such as complainants may be created. These accommodation support documents 1432 may include letters requesting or approving extra time on course exams or class assignments, interpreters, and additional support persons for a complainant.

In certain examples, exemplary interfaces 1400-1402 or other user interfaces may also provide editable settings for adding, removing, ordering, and requiring custom fields in one or more user interfaces of the caseload management system, including: check boxes, drop-down menus, input fields, text areas, date, and date and time.

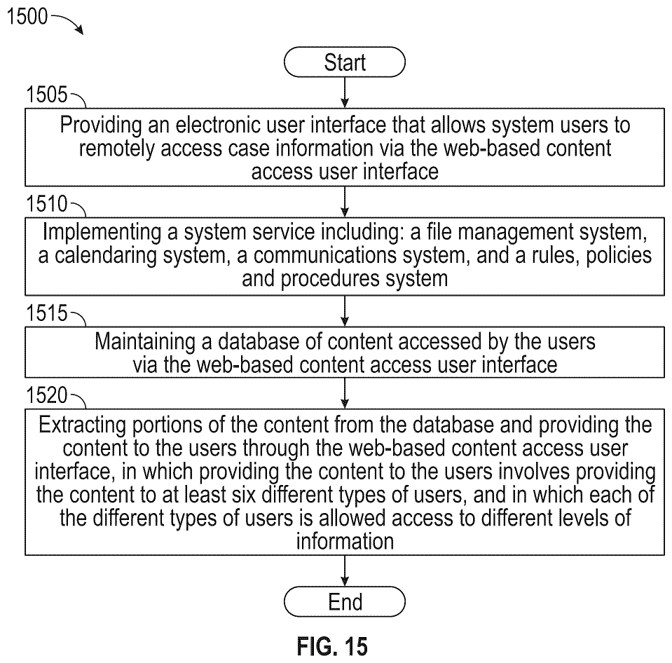

FIG. 15 is a flow chart illustrating a method 1500 performed in an exemplary distributed response and resolution caseload management system having a web-based content access user interface.

Method 1500 begins at block 1505 with providing an electronic user interface that allows system users to remotely access case information via the web-based content access user interface.

Method 1500 continues at block 1510 with implementing a system service including: a file management system, a calendaring system, a communications system, and a rules, policies and procedures system.

Method 1500 continues at block 1515 with maintaining a database of content accessed by the users via the web-based content access user interface.

Method 1500 concludes at block 1520 with extracting portions of the content from the database and providing the content to the users through the web-based content access user interface, in which providing the content to the users involves providing the content to at least six different types of users, in which each of the different types of users is allowed access to different levels of information.

According to certain examples of method 1500, the at least six different types of users include case coordinators, case investigators, institutional stakeholders, a complainant and respondent in a particular case, advisors or attorneys to the complainant and respondent, and decisionmakers.

According to certain examples of method 1500, at least the case coordinators, the case investigators and the institutional stakeholders are each allowed to access content related to multiple response and resolution cases.

All publications and patent applications mentioned in this specification are herein incorporated by reference in their entirety to the same extent as if each individual publication or patent application was specifically and individually indicated to be incorporated by reference.

Furthermore, it should be appreciated that all combinations of the foregoing concepts (provided such concepts are not mutually inconsistent) are contemplated as being part of the inventive subject matter disclosed herein and may be used to achieve the benefits described herein.

A person of ordinary skill in the art will recognize that any process or method disclosed herein can be modified in many ways. The process parameters and sequence of the steps described and/or illustrated herein are given by way of example only and can be varied as desired. For example, while the steps illustrated and/or described herein may be shown or discussed in a particular order, these steps do not necessarily need to be performed in the order illustrated or discussed.

The various exemplary methods described and/or illustrated herein may also omit one or more of the steps described or illustrated herein or comprise additional steps in addition to those disclosed. Further, a step of any method as disclosed herein can be combined with any one or more steps of any other method as disclosed herein.

When a feature or element is herein referred to as being “on” another feature or element, it can be directly on the other feature or element or intervening features and/or elements may also be present. In contrast, when a feature or element is referred to as being “directly on” another feature or element, there are no intervening features or elements present. It will also be understood that, when a feature or element is referred to as being “connected”, “attached” or “coupled” to another feature or element, it can be directly connected, attached or coupled to the other feature or element or intervening features or elements may be present. In contrast, when a feature or element is referred to as being “directly connected”, “directly attached” or “directly coupled”to another feature or element, there are no intervening features or elements present.

Although described or shown with respect to one embodiment, the features and elements so described or shown can apply to other embodiments. It will also be appreciated by those of skill in the art that references to a structure or feature that is disposed “adjacent” another feature may have portions that overlap or underlie the adjacent feature.

Terminology used herein is for the purpose of describing particular embodiments only and is not intended to be limiting of the invention. For example, as used herein, the singular forms “a”, “an” and “the” are intended to include the plural forms as well, unless the context clearly indicates otherwise. It will be further understood that the terms “comprises” and/or “comprising,” when used in this specification, specify the presence of stated features, steps, operations, elements, and/or components, but do not preclude the presence or addition of one or more other features, steps, operations, elements, components, and/or groups thereof. As used herein, the term “and/or” includes any and all combinations of one or more of the associated listed items and may be abbreviated as “/”.

Spatially relative terms, such as “under”, “below”, “lower”, “over”, “upper” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if a device in the figures is inverted, elements described as “under”, or “beneath” other elements or features would then be oriented “over” the other elements or features. Thus, the exemplary term “under” can encompass both an orientation of over and under. The device may be otherwise oriented (rotated 90 degrees or at other orientations) and the spatially relative descriptors used herein interpreted accordingly. Similarly, the terms “upwardly”, “downwardly”, “vertical”, “horizontal” and the like are used herein for the purpose of explanation only unless specifically indicated otherwise.

Although the terms “first” and “second” may be used herein to describe various features/elements (including steps), these features/elements should not be limited by these terms, unless the context indicates otherwise. These terms may be used to distinguish one feature/element from another feature/element. Thus, a first feature/element discussed below could be termed a second feature/element, and similarly, a second feature/element discussed below could be termed a first feature/element without departing from the teachings of the present invention.

In general, any of the apparatuses and methods described herein should be understood to be inclusive, but all or a sub-set of the components and/or steps may alternatively be exclusive and may be expressed as “consisting of” or alternatively “consisting essentially of” the various components, steps, sub-components or sub-steps.

As used herein in the specification and claims, including as used in the examples and unless otherwise expressly specified, all numbers may be read as if prefaced by the word “about” or “approximately,” even if the term does not expressly appear. The phrase “about” or “approximately” may be used when describing magnitude and/or position to indicate that the value and/or position described is within a reasonable expected range of values and/or positions. For example, a numeric value may have a value that is +/−0.1% of the stated value (or range of values), +/−1% of the stated value (or range of values), +/−2% of the stated value (or range of values), +/−5% of the stated value (or range of values), +/−10% of the stated value (or range of values), etc. Any numerical values given herein should also be understood to include about or approximately that value, unless the context indicates otherwise. For example, if the value “10” is disclosed, then “about 10” is also disclosed. Any numerical range recited herein is intended to include all sub-ranges subsumed therein. It is also understood that when a value is disclosed that is “less than or equal to” the value, “greater than or equal to the value” and possible ranges between values are also disclosed, as appropriately understood by the skilled artisan. For example, if the value “X” is disclosed the “less than or equal to X” as well as “greater than or equal to X” (e.g., where X is a numerical value) is also disclosed. It is also understood that throughout the application, data is provided in a number of different formats, and that this data, represents endpoints and starting points, and ranges for any combination of the data points. For example, if a particular data point “10” and a particular data point “15” are disclosed, it is understood that greater than, greater than or equal to, less than, less than or equal to, and equal to 10 and 15 are considered disclosed as well as between 10 and 15. It is also understood that each unit between two particular units are also disclosed. For example, if 10 and 15 are disclosed, then 11, 12, 13, and 14 are also disclosed.

Although various illustrative embodiments are described above, any of a number of changes may be made to various embodiments without departing from the scope of the invention as described by the claims. Optional features of various device and system embodiments may be included in some embodiments and not in others. Therefore, the foregoing description is provided primarily for exemplary purposes and should not be interpreted to limit the scope of the invention as it is set forth in the claims.

The examples and illustrations included herein show, by way of illustration and not of limitation, specific embodiments in which the subject matter may be practiced. As mentioned, other embodiments may be utilized and derived there from, such that structural and logical substitutions and changes may be made without departing from the scope of this disclosure. Such embodiments of the inventive subject matter may be referred to herein individually or collectively by the term “invention” merely for convenience and without intending to voluntarily limit the scope of this application to any single invention or inventive concept, if more than one is, in fact, disclosed. Thus, although specific embodiments have been illustrated and described herein, any arrangement calculated to achieve the same purpose may be substituted for the specific embodiments shown. This disclosure is intended to cover any and all adaptations or variations of various embodiments. Combinations of the above embodiments, and other embodiments not specifically described herein, will be apparent to those of skill in the art upon reviewing the above description.

1. A case management system for case distribution, the system comprising:
a processor, and
a non-transitory computer readable medium having stored thereon computer executable instructions that, when executed by the processor, cause the processor to:
provide an electronic user interface that allows system users to remotely access case information via the web-based content access user interface;
implement a system service including: a file management system, a calendaring system, a communications system, and a rules, policies and procedures system;
maintain a centralized database of content accessed by the users via the web-based content access user interface;
receive new content based on case progress in real-time to create modified content including customizing the case management system to institutional parameters and terminology, and identifying and applying regulations to the content; and
extract portions of the content from the database and provide the content including the modified content to the users through the web-based content access user interface,
wherein providing the content including the modified content to the users involves providing the content including the modified content to at least six different types of users, and wherein each of the different types of users is allowed access to different levels of information from the centralized database containing the modified content in real-time, further wherein a user interface for the new content is customized to one or more of: case parameters, institutional parameters, and preferences of at least one of the six different types of users.

2. The system of claim 1, wherein the at least six different types of users include case coordinators, case investigators, institutional stakeholders, a complainant and respondent in a particular case, advisors or attorneys to the complainant and respondent, and decisionmakers, wherein the preferences of the at least six different types of users include a frequency and type of case update status received, further wherein the complainants control the modified content presented to the advisors and active status of the advisors in the case management system via advisor user interfaces; further comprising a user interface for modifying custom fields in one or more user interfaces of the case management system; further comprising a client preferences user interface configured for creating document templates.

3. The system of claim 2, wherein at least the case coordinators, the case investigators and the institutional stakeholders are each allowed to access content including the modified content related to multiple response and resolution cases.

4. The system of claim 2, wherein the case investigators are provided access to less content including the modified content than the case coordinators are, and the institutional stakeholders are provided access to less content than the case investigators are.

5. The system of claim 1, wherein the communications system is configured to receive, store, sort, display, create and send email messages between the users and track the email messages relative to a case to which they relate.

6. The system of claim 1, wherein the communications system is configured to send updates to the users.

7. The system of claim 1, wherein the communications system is configured to allow a complainant and a respondent to restrict times during which they receive communications, further wherein the communications system is configured to allow the complainant and respondent to restrict at least one of the six different types of users from receiving communications from the communications system, wherein the at least one of the six different types of users includes the advisors or attorneys to the complainant and respondent.

8. The system of claim 1, wherein the rules, policies and procedures system is configured to store and retrieve rules, policies and procedures related to federal, state, and organization-specific laws and policies relating to at least one of a group including: sex-based discrimination, diversity, equity, and inclusion.

9. The system of claim 1, wherein the rules, policies and procedures system is configured to automatically provide time-sensitive alerts to at least some of the users based on requirements found in the rules, policies and procedures.

10. The system of claim 1, wherein the rules, policies and procedures system is configured to automatically provide alerts to at least some of the users based on requirements found in the rules, policies and procedures, after resolving conflicts between inconsistent requirements.

11. The system of claim 10, wherein the rules, policies and procedures system is configured to resolve the conflicts between the inconsistent requirements based at least in part on case-specific information that has been previously stored in the database.

12. The system of claim 11, wherein the case-specific information includes at least one of the following selected from a group consisting of the state in which an incident occurred, a specific location in which the incident occurred, the date an incident occurred, and a position held by the complainant and/or the respondent.

13. The system of claim 1, wherein the file management system is configured to allow the users to upload evidence and information directly onto the system.

14. The system of claim 1, wherein providing the content including the modified content to the users includes allowing supervisors to monitor progress of a case in real time.

15. The system of claim 1, wherein the system is configured to simultaneously share status updates with parties on both a portal and through a text message or email format.

16. The system of claim 1, wherein the system is configured to allow the users to select one or multiple do not disturb times, during which information and system updates are added to the portal, but the system does not send the user a text message or email, as they direct.

17. The system of claim 2, wherein the system is configured to allow the case coordinators or the case investigators to access a color-coding system that informs them when deadlines are coming up soon or are overdue.

18. The system of claim 2, wherein the system is configured to allow the case coordinators and the case investigators to go backwards within a case timeline and reopen a previous version of an item after it has been changed.

19. The system of claim 2, wherein the system is configured to allow the institutional stakeholders to update policies in the system, and the system applies updated procedural steps to future cases based on the updated policies.

20. The system of claim 2, wherein the system is configured to allow the institutional stakeholders to make procedural changes based on changes to law or regulation, and wherein the system automatically changes process steps and requirements in future cases based on the procedural changes made by the institutional stakeholders.

21. The system of claim 1, wherein the system is configured to allow the users to make changes to a case via an application residing on a mobile device and have those changes be instantly reflected on a web browser interface, and vice versa.

22. The system of claim 1, wherein the system is configured to allow one of the users to transfer a matter to another coordinator or advisor through a series of clicks which instantaneously moves the matter to a dashboard associated with the other coordinator or advisor.

23. The system of claim 1, wherein a digital watermark is applied to one or more of case documents and the user interfaces accessed within the distributed system, wherein the digital watermark identifies the one of the six different types of users accessing the watermarked document or user interface.

24. A method, comprising:
providing an electronic user interface that allows system users to remotely access case information via a web-based content access user interface of a case management system for case distribution;
implementing a system service including: a file management system, a calendaring system, a communications system, and a rules, policies and procedures system;
maintaining a centralized database of content accessed by the users via the web-based content access user interface;
receiving new content based on case progress in real-time;
creating modified content including customizing the case management system to institutional parameters and terminology, and identifying and applying regulations to the content;
and
extracting portions of the content from the database and providing the content including the modified content to the users through the web-based content access user interface,
wherein providing the content including the modified content to the users involves providing the content including the modified content to at least six different types of users, and wherein each of the different types of users is allowed access to different levels of information from the centralized database containing the modified content in real-time, further wherein a user interface for the new content is customized to one or more of: case parameters, institutional parameters, and preferences of at least one of the six different types of users.

25. The method of claim 24, wherein the at least six different types of users include case coordinators, case investigators, institutional stakeholders, a complainant and respondent in a particular case, advisors or attorneys to the complainant and respondent, and decisionmakers, wherein the preferences of the at least six different types of users include a frequency and type of case update status received, further wherein the complainants control the modified content presented to the advisors and active status of the advisors in the case management system via adviser user interfaces; further comprising a user interface for modifying custom fields in one or more user interfaces of the case management system; further comprising a client preferences user interface configured for creating document templates.

26. The method of claim 25, wherein at least the case coordinators, the case investigators and the institutional stakeholders are each allowed to access content related to multiple response and resolution cases.

27. A non-transitory computer-readable medium having stored thereon computer executable instructions that, when executed by a processor, cause the processor to perform operations of:
providing an electronic user interface that allows system users to remotely access case information via the web-based content access user interface;
implementing a system service including: a file management system, a calendaring system, a communications system, and a rules, policies and procedures system;
maintaining a centralized database of content accessed by the users via the web-based content access user interface;
receiving new content based on case progress in real-time;
creating modified content including customizing the case management system to institutional parameters and terminology, and identifying and applying regulations to the content;
and
extracting portions of the content from the database and providing the content including the modified content to the users through the web-based content access user interface,
wherein providing the content including the modified content to the users involves providing the content including the modified content to at least six different types of users, and wherein each of the different types of users is allowed access to different levels of information from the centralized database containing the modified content in real-time, further wherein a user interface for the new content is customized to one or more of: case parameters, institutional parameters, and preferences of at least one of the six different types of users.

28. The non-transitory computer-readable medium of claim 27, wherein the at least six different types of users include case coordinators, case investigators, institutional stakeholders, a complainant and respondent in a particular case, advisors or attorneys to the complainant and respondent, and decisionmakers, wherein the preferences of the at least six different types of users include a frequency and type of case update status received, further wherein the complainants control the modified content presented to the advisors and active status of the advisors in the case management system via advisor user interfaces; further comprising a user interface for modifying custom fields in one or more user interfaces of the case management system; further comprising a client preferences user interface configured for creating document templates.

29. The non-transitory computer-readable medium of claim 28, wherein at least the case coordinators, the case investigators and the institutional stakeholders are each allowed to access content related to multiple response and resolution cases.
